(19) United States
(12) Patent Application Publication
(10) Pub. No.: US 2026/0009728 A1
(43) Pub. Date: Jan. 8, 2026

(54) SYSTEMS AND METHODS FOR DETECTING CARBURIZATION

(71) Applicant: SABIC Global Technologies B.V., Bergen OP Zoom (NL)

(72) Inventor: Khalid Rahil Sheltami, Jubail (SA)

(21) Appl. No.: 19/279,056

(22) Filed: Jul. 24, 2025

Related U.S. Application Data
(60) Provisional application No. 63/666,849, filed on Jul. 2, 2024.

(51) Int. Cl. G01N 21/47

(52) U.S. Cl. CPC G01N 21/47; G01N 2021/4735

(57) ABSTRACT

Example methods and related systems for determining a level or amount of carburization in a furnace coil are described. For instance, an embodiment of a method includes directing photons having an energy in a range from 80 to 140 kiloelectronvolts (keV) toward a coil of an ethylene furnace. In addition, the method includes obtaining a photon count for the photons that are emitted from the coil. Further, the method includes determining an amount of carburization in the coil based on the photon count.

### TECHNICAL FIELD

This disclosure generally relates to systems and methods of determining an amount of carburization on metallic surfaces. More particularly, this disclosure relates to systems and methods for detecting or quantifying carburization of a furnace coil, such as a furnace coil used in an ethylene furnace.

### BACKGROUND

Ethylene cracking furnaces may be used to convert various hydrocarbons, such as ethane and propane, into more desirable olefins, such as ethylene and propylene. Generally, a hydrocarbon feed is passed with steam through tubes or coils within the furnace that are heated to high temperatures (such as ranging from 900° C. to 1200° C.). At these high temperatures, furnace coils are prone to carburization, or the absorption of carbon atoms into the steel structure of the furnace coils. Carburization causes steel tubes to become harder, less ductile, and therefore more prone to brittle failure. As a result, monitoring carburization is important to prevent failure of the furnace coils.

### SUMMARY

As noted above, existing furnace coils can carburize over time, which negatively affects operation of furnaces, such as ethylene cracking furnaces. However, monitoring carburization of coils is often an expensive or time-consuming process, which involves destructive testing or removal and replacement of inspected coils. As such, the present disclosure addresses these and other problems by providing systems and methods for detecting carburization of coils via non-destructive testing that leverages radiographic inspection techniques with specifically generated curves or relationships associating photon detection and carburization amounts.

In more detail, an irradiation device is coupled with a photon detector quantify an amount, level, or thickness of carburization of a coil, while enabling the coil to remain in an installed position. The irradiation device can direct photons having a particular photon energy, such as an energy between 85-135 kiloelectronvolts (keV) toward an inspected surface of the coil. As such, the photon detector captures a photon count and/or other quantitative data representative of photons emitted or backscattered by the coil in response to the photons of the irradiation device. A predetermined curve or relationship is provided to associate the detected photons with quantities of carburization, as based on actual measurements performed on various coils with known carburization levels. Different curves are included for each of multiple different coil materials and can be further refined or differentiated based on cross-sectional dimensions of coils. A controller, user interface, or other computing device coupled to and/or included in the irradiation device and photon detector can thus rapidly evaluate the level of carburization of a particular coil based on the predetermined curves. In some embodiments, the controller compares the level of carburization to a predetermined threshold and instigates control actions (e.g., transmitting alerts, scheduling replacement) in response to the carburization exceeding the predetermined threshold.

The disclosure herein provides several embodiments of systems and methods for detecting or quantifying carburization of a furnace coil based on radiographic inspection techniques. Embodiments include a method that includes directing photons having an energy in a range from 80 to 140 kiloelectronvolts (keV) toward a coil of an ethylene furnace. The method includes obtaining a photon count for the photons that are emitted from the coil and determining an amount of carburization in the coil based on the photon count.

In some embodiments, the directing includes directing the photons onto a first side of the coil and the obtaining includes obtaining a photon count for photons emitted from a second side of the coil. The second side is opposite the first side. In some embodiments, the obtaining includes using computed tomography (CT) with a complementary metal-oxide semiconductor (CMOS) panel.

In some embodiments, the determining includes comparing the photon count to a predetermined model indicating a relationship between photon counts and amounts of carburization. In some embodiments, the predetermined model includes one or more of a curve, a chart, a table, or a mathematical expression. In some embodiments, the method includes selecting the predetermined model from a plurality of predetermined models based on a material of the coil. In some embodiments, the method includes generating the predetermined model by acquiring a plurality of coils each having a respective amount of carburization and directing photons toward the plurality of coils to determine a relationship between the respective amount of carburization and photon count for each coil of the plurality of coils.

In some embodiments, the method includes determining whether the amount of carburization exceeds a predetermined threshold amount of carburization and activating an alarm or transmitting an alert in response to the amount being greater than the threshold amount. In some embodiments, the range includes from 80 to 100 keV.

Examples include a system that includes an irradiation device, a photon detector, and a controller communicatively coupled to the irradiation device and the photon detector. The controller includes processor-executable instructions to instruct the irradiation device to direct photons having an energy in a range from 80 to 140 kiloelectronvolts (keV) toward a coil of an ethylene furnace. The controller includes processor-executable instructions to obtain a photon count for the photons that are emitted from the coil via the photon detector and quantify an amount of carburization in the coil based on the photon count.

In some embodiments, the controller is configured to quantify the amount of carburization by comparing the photon count to a predetermined model indicating a relationship between photon counts and amounts of carburization for a material of the coil. The material of the coil includes an alloy containing chromium, nickel, and iron. In some embodiments, the controller is configured to determine whether the amount of carburization exceeds a threshold amount and activate an alarm or transmit an alert in response to the amount being greater than the threshold amount.

In some embodiments, the irradiation device is configured to direct the photons onto a first side of the coil and the photon detector is configured to obtain a photon count for photons emitted from a second side of the coil. The second side is opposite the first side. In some embodiments, the system includes a pipe crawler coupled to support the irradiation device and the photon detector. The pipe crawler is configured to translate along an outer surface of the coil and maintain the irradiation device and the photon detector at a constant distance from the outer surface. In some embodiments, the photon detector includes a complementary metal-oxide semiconductor (CMOS) panel and the range includes from 85 to 135 keV.

Still other aspects and advantages of these exemplary embodiments and other embodiments, are discussed in detail herein. Moreover, it is to be understood that both the foregoing information and the following detailed description provide merely illustrative examples of various aspects and embodiments, and are intended to provide an overview or framework for understanding the nature and character of the claimed aspects and embodiments. Furthermore, it is to be understood that the features of the various embodiments described herein are not mutually exclusive and may exist in various combinations and permutations.

### BRIEF DESCRIPTION OF THE DRAWINGS

Embodiments will be readily understood by the following detailed description in conjunction with the accompanying drawings. To facilitate this description, like reference numerals designate like structural elements or procedures in a method. Embodiments are illustrated by way of example and not by way of limitation in the accompanying drawings. The present disclosure can be better understood by referring to the following figures. These drawings illustrate the principles of the disclosure and no limitation of the scope of the disclosure is thereby intended.

FIGS. 1A and 1B are schematic diagrams of embodiments of systems for determining a carburization amount for a metal target, according to some embodiments disclosed herein.

FIGS. 2A and 2B are schematic diagrams of additional embodiments of the systems of FIGS. 1A and 1B, according to some embodiments disclosed herein.

FIG. 3 is a schematic diagram of the system of FIG. 1A for performing a carburization determination operation on a furnace coil, according to some embodiments disclosed herein.

FIG. 4 is an example chart correlating the photon energy emitted from the metal target and an amount of carburization (in layers), according to some embodiments disclosed herein.

FIG. 5 is flow diagram of a method for detecting and monitoring carburization in furnace coils, according to some embodiments disclosed herein.

### DETAILED DESCRIPTION

As previously described furnace coils, such ethylene furnace coils, are prone to carburization. Conventionally, methods for detecting or rectifying carburization on furnace coils include time-based replacements and/or destructive testing, which may involve cutting sections from the furnace coils and potentially welding any acceptable sections back in place. Non-destructive testing methods using electromagnetics or eddy-currents on a metal target have been used to determine carburization level or amount; however, such testing methods have their own shortcomings. For example, when using eddy-current testing, the metal target must have suitable conductivity, and the metal target must be placed through electric coils to induce a magnetic field. Additionally, carburization layers on steel could affect magnetic signals, causing inaccurate readings. Moreover, the use of electromagnetic testing may also consume additional time that extends plant downtime and leads to undesired production losses.

Accordingly, embodiments disclosed herein include systems and methods for detecting carburization on metal targets, such as, for example, furnace coils, that do not suffer from the same drawbacks typically associated with conventional testing methods. As a result, embodiments disclosed herein may overcome the issues of testing time, preparation of samples, and shutdown extensions, among others. In some embodiments, the disclosed systems and methods utilize radiography photon counting to predict or estimate the energy absorbed by different layers of a metal target, and thereby quantify carburization in the inspected location. Based on the detected and/or quantified carburization, effective control measures, such as coil repair or replacement, can be scheduled and implemented during convenient time periods.

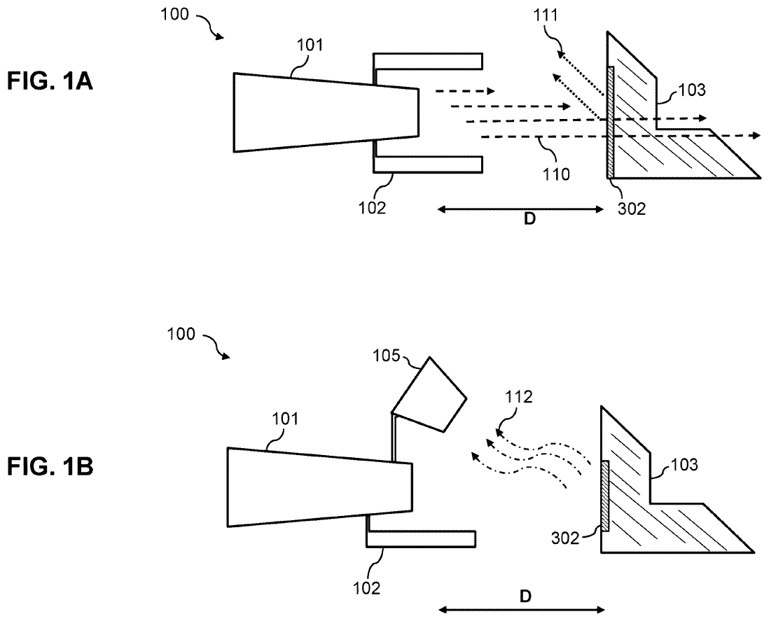

FIG. 1A shows an embodiment of a system 100 for determining a carburization amount for a metal target, such as a furnace coil, tube, or conduit used in an ethylene furnace, according to some embodiments disclosed herein. The system 100 includes an irradiation device 101 that is placed at a distance (D) from a metal target 103. The metal target 103 may be a furnace coil or a portion or surface thereof. In some examples, the metal target 103 is formed of an alloy containing chromium, nickel, and iron. Additionally, the distance (D) may be selected or calibrated depending on the surface area to be inspected. For example, the distance (D) may be less or greater than 20 cm, in some embodiments. The system 100 also includes a photon detector 102 (or photon counting detector) that is placed adjacent to the irradiation device 101 to detect any emitted or backscattered photons from the metal target 103. In some embodiments, the photon detector 102 is placed around, such as circumferentially around, at least a portion of the irradiation device 101. However, any suitable relative positioning and orientations between the irradiation device 101 and the photon detector 102 are contemplated herein. The photon detector 102 may be a photomultiplier detector or any other suitable detector(s) as would be known by one having ordinary skill in the art. In some embodiments, the photon detector 102 may include a complementary metal-oxide semiconductor (CMOS) panel detector, a scintillation detector, solid-state detector, or other appropriate radiation sensors capable of accurately measuring and detecting a specific radiation and energy range.

During operations, the irradiation device 101 is activated and directs photons 110 toward a desired surface of the metal target 103. Backscattered photons 111 emitted from the metal target 103 are then counted or measured by the photon detector 102, as shown in FIG. 1A The irradiation device 101 and the photon detector 102 are portable and may be moved vertically as well as horizontally to cover different surface areas or external surfaces of the metal target 103. In certain embodiments, the irradiation device 101 and the photon detector 102 are coupled to a common structure or device to enhance the consistency and convenience of carburization evaluation herein.

The irradiation device 101 can emit photons with a preselected energy or photon energy that is determined based on various properties of the metal target 103. In some embodiments, the photon energy is selected as a higher value for materials having greater densities, thicknesses, operational times, and/or levels of predicted carburization, while the photon energy is selected as a lower value for materials having lesser densities, thicknesses, operational times, and/or predicted carburization levels. For example, the irradiation device 101 emits photons having an energy of more than about 60, 65, 70, 75, 80, 85, or 90 kiloelectronvolts (keV), in some embodiments. In some of these and other embodiments, the irradiation device 101 emits photons having an energy of less than about 150, 145, 140, 135, 130, 125, 120, 115, or 110 keV. As non-limiting examples, the irradiation device 101 can emit photons having an energy in a range of about 85-135, 85-130, 85-125, 85-120, 85-115, 85-110, 85-105, 85-100, 90-135, 95-135, 100-135, 105-135, 110-135, 115-135, or 120-135, or any suitable subrange or values therein.

In some embodiments, the irradiation device 101 emits photons having an energy that is less than that of gamma rays. For instance, in some embodiments, the irradiation device 101 emits photons having an energy less than 100 keV. However, in other embodiments, the irradiation device 101 may emit photons in the form of gamma rays with energies greater than 100 keV, such as, for instances with energies from about 100 to about 100,000 eV. In some embodiments, the irradiation device 101 may be configured to use any suitable radiation source, such as for example, cobalt-60, americium-241, or caesium-137. Further, in some embodiments, the irradiation device 101 may be configured to inject photons with energies higher than those in the form of X-ray or gamma rays.

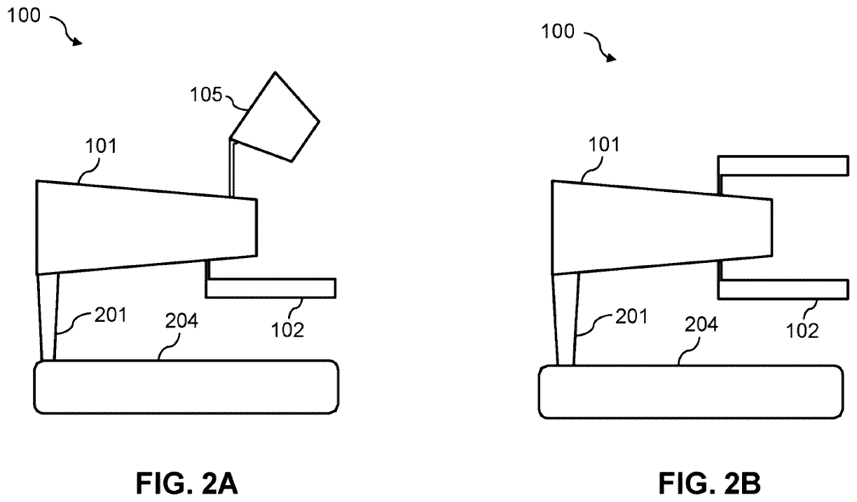

As shown in FIGS. 1B and 2A, in some embodiments, the system 100 may include an infrared thermography device 105 connected to the irradiation device 101. The infrared thermography device 105 may be targeted or oriented toward the metal target 103 to analyze the temperature distribution on the surface of the metal target 103. In some embodiments, the infrared thermography device 105 is configured to produce an image (such as on an electronic display that is communicatively coupled to the infrared thermography device 105) that represents the temperature distribution on the surface of the metal target 103. For example, the infrared thermography device 105 may produce an image based on receiving and analyzing infrared energy 112 emitted from the metal target 103. Without being limited to this or any other theory, areas with higher carburization levels may exhibit different temperature patterns and distributions compared to unaffected or non-carburized regions. As such, analyzing the temperature distribution across the surface of the metal target 103 may allow for qualitative and/or quantitative assessment of carburization, such as via a controller. Further, a combination of radiation and infrared thermography (via the infrared thermography device 105) may be employed to provide better results and precision to the carburization detection operations. For example, in some embodiments the infrared thermography device 105 may be used to initially detect carburization, and then the irradiation device 101 and photon detector 102 may be used to provide more precise determination of the depth and composition of the carburization as described herein. This preliminary detection via the infrared thermography device 105 can thus reduce or conserve the energy and time utilized during carburization assessment, while still delivering quantitative, reliable measurements via the irradiation device 101 and the photon detector 102. In some examples, the infrared thermography device 105 can be implemented to confirm results provided by the irradiation device 101 and photon detector 102.

As shown in FIGS. 2A and 2B, in some embodiments, the system 100 having the irradiation device 101 (along with the photon detector 102, the infrared thermography device 105, and/or other device(s) connected to the irradiation device 101) may include, be placed on, or be coupled to a moving platform 200 that is configured to engage with and/or traverse along a furnace coil. For instance, the platform 200 may be a crawler (such as a pipe crawler), an unmanned aerial vehicle, or a wheeled platform. The platform 200 may include one or more mounting poles 201 that are used to hold and support the irradiation device 101 during operations. For example, the platform 200 can support the irradiation device 101 and the photon detector 102 while the platform is translated along an outer surface of a furnace coil and maintain the irradiation device 101 and the photon detector 102 at a constant distance from the outer surface.

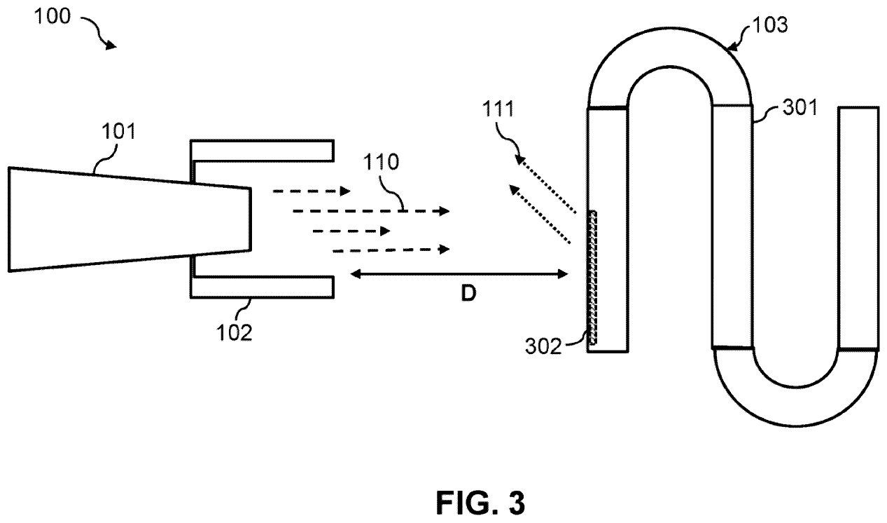

FIG. 3 shows the system 100 performing a carburization detection operation according to some embodiments. In FIG. 3, the metal target 103 is more clearly depicted as a furnace coil. The metal target 103 may include one or more carburization layers 301 and one or more aluminum oxide layers 302. For example, certain metal targets 103 can include anti-coke coils with aluminum oxide. Generally, the irradiation device 101 is placed at the distance D from the metal target 103, and is activated to emit photons 110 toward the metal target 103 (or a desired surface thereof), the photon detectors 102 are placed and adjusted so as to capture the backscattered photons 111 emitted from the metal target 103. Generally, the photons 110 emitted from the irradiation device 101 interact with the surface layers of the metal target 103. Specifically, as the photons 110 penetrate the surface, they undergo various physical interactions, such as scattering and absorption. These interactions are influenced by the composition and characteristics of the material of the metal target 103, as well as the presence and extent of carburization. The backscattered or emitted back photons 111 from the metal target 103 are then detected by the photon detector 102.

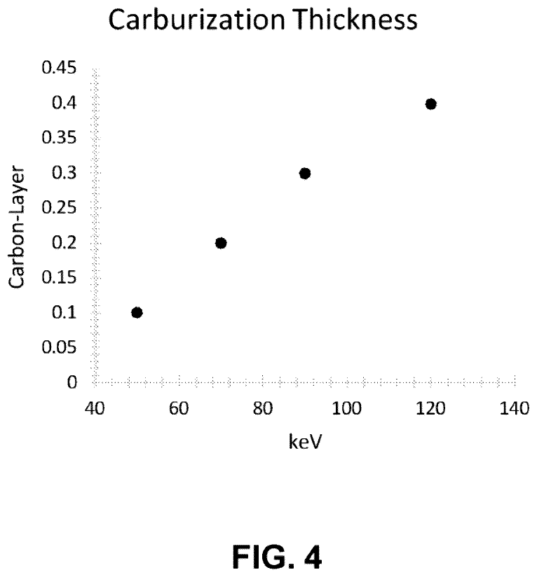

In some embodiments, a relationship is derived between the photon count detected by the photon detector 102 and the amount of thickness of carburization in and/or on the metal target 103. For instance, in some embodiments, the relationship may be embodied in a curve, chart, table, algorithm, formula, general rule, and so forth. FIG. 4 shows an example chart that illustrates an example relationship between carburization thickness and the photon count. The level of precision generated from the chart may be between 0-15% in some embodiments. In some embodiments, the chart enables determination of an amount of carburization that is within 10% of an actual amount of carburization (e.g., as verifiable with destructive testing and/or metallurgical testing). However, higher and/or lower precision values are also contemplated and may be improved with the evaluation and inclusion of additional samples in a given relationship. Moreover, in some embodiments, a different chart, relationship, or model between carburization thickness and photon count is established for each material or alloy composition used in one or more furnace coils. In some of these embodiments, a particular model can be selected from multiple predetermined models based on one or more matches between respective qualities and/or characteristics of an inspected metal target 103 and metal targets used to generate the predetermined models.

Additionally, in some embodiments, the relationship can be embodied in a model that can be used to achieve efficient and accurate carburization inspection on samples based on detected photon counts as previously described. For example, the model may include a mathematical expression that is developed via experimental data to identify patterns and correlations between the released photon energy, carburization levels, absorption coefficient, furnace coil alloy composition, shape, and/or type, and so forth. Statistical methods and correlation analysis can be employed to derive the mathematical model from such experimental data. Further, the model may provide, as an output, carburization layer thickness and/or material structure of the sample (such as a furnace coil) being tested.

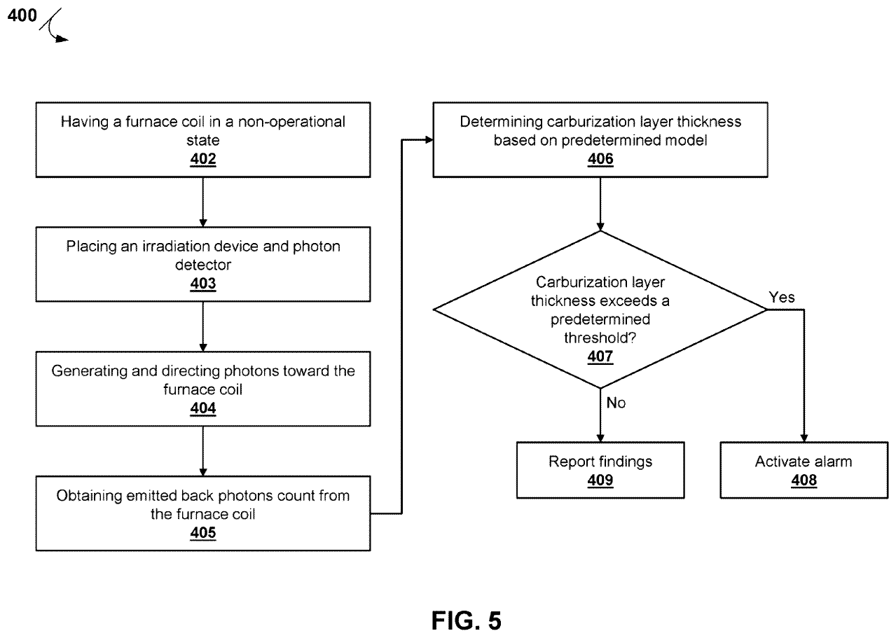

FIG. 5 is flow diagram of a method 400 for detecting and monitoring carburization in furnace coils according to some embodiments disclosed herein. In some embodiments, the steps of method 400 may be completed using embodiments of the system 100 discussed above; however, method 400 may also be performed with other systems and devices that are different from the system 100 in one or more respects. The order in which the operations are described or shown is not intended to be construed as a limitation, and any number of the described blocks may be combined in any order and/or in parallel to implement embodiments of method 400. In some embodiments, one or more features of the method 400 may be performed (at least partially) by a controller (such as a controller of or coupled to the system 100) that includes one or more processors that execute machine readable, processor-executable instructions stored on one or more memory devices.

At block 402, a furnace coil is placed in non-operational state. For example, a typical cracking furnace coil operates at temperatures between 900° C. to 1200° C., and carburization detection at these temperatures is not recommended due to the associated changes in the absorption behavior of metals, which could result in inaccurate readings. As such, the furnace coil shall be placed in the non-operational state to enable the temperature of the furnace coil to stabilize at ambient temperature.

At block 403, an irradiation device 101 and a photon detector 102 are placed on the furnace coil in the non-operational state. The irradiation device 101 is positioned at a distance (such as the distance D previously described) from the furnace coil. The distance may be changed depending on the surface area to be inspected. In some embodiments, the irradiation device 101 and/or the photon detector 102 are coupled to a pipe crawler, which supports the irradiation device 101 and/or the photon detector 102 at a specified distance relative to the furnace coil, while enabling efficient translation along outer surfaces of the furnace coil to be evaluated.

At block 404, the irradiation device 101 generates and directs photons toward the furnace coil. As previously discussed, the photons are generated with a specified photon energy or energy level that interacts with material of the furnace coil, which emits or backscatters photons having qualities and/or quantities based on the current state of the furnace coil. At block 405, the photon detector 102 obtains a reading of the photons emitted or backscattered from the furnace coil. At block 406, the thickness of the carburization layer is determined based on a predetermined model that correlates one or more qualities and/or quantities of the backscattered photons to various thicknesses of carburization. As an example, a count or quantification of the backscattered photons can be compared to a model generated based on experimental data correlating backscattered photon count and carburization thickness. In some embodiments, the backscattered photons are analyzed with the model to determine a carburization amount, level, degree, or other quantity, in addition or alternative to the thickness.

At block 407, the carburization layer thickness is compared to a predetermined threshold (e.g., threshold thickness, threshold amount, threshold level, threshold degree). If the measured carburization layer thickness exceeds the predetermined threshold, then an alarm or notification can be sent to the operator to take an immediate action and proceed with a proper remedy, as shown in block 408. If the threshold is not exceeded at block 407, then the findings are reported or documented, and different surface areas of the furnace coil can be tested, as shown in block 409. In some embodiments, multiple tests can be performed on a same area over a period of time and, based on any trend (e.g., slope, acceleration) between test result data, an estimate can be provided to indicate a predicted time at which the carburization layer thickness exceeds the predetermined threshold. In some embodiments, such predictions can enable efficient scheduling of one or more repair and/or replacement operations during scheduled shutdowns or when multiple repairs to be completed are identified.

### EXAMPLES

The following examples are put forth so as to provide those of ordinary skill in the art with a complete disclosure and description of how the systems, methods, articles, and/or devices claimed herein are made and utilized. The following examples are intended to be purely exemplary and are not intended to limit the disclosure.

### Example 1: Investigating Carburization of Various Furnace Coils

As described above, the systems and methods disclosed herein can facilitate rapid and accurate non-destructive testing of coils, such as furnace coils of an ethylene furnace. It is recognized that carburization is generally a non-uniform process, which can affect material in different ways along a circumference and/or a longitudinal axis of a given coil. For the present experiments, assumptions were made that carburization is equally distributed across circumferentially opposite sides of each coil, such that a first side at which an irradiation device directs photons to a surface has a similar carburization as a second side, opposite the first side, at which a photon detector receives photons emitted or backscattered by the second side.

Experiments to validate the present systems and methods were performed on three different coils, which each included a different level of carburization. Each of the three coils were inspected in multiple locations via a computed tomography (CT) inspection method, which collects three-dimensional scanning data representative of each scanned portion of a given coil. The CT inspection method herein also utilized a CMOS flat panel detector as a photon detector, and photons were directed to the scanned portions of coil with energy levels ranging from 85-135 keV. The resulting data was analyzed via the above-described method to provide an estimated amount (e.g., level, range, thickness, or degree) of carburization at each scanned portion of each coil.

After using the CT inspection method, the coils were subjected to metallurgical inspection or analysis, such as microscopic examination, mechanical testing, chemical testing, and/or destructive testing, to identify the exact level of carburization. Table 1 below shows the results from these experiments.

TABLE 1
Materials and Carburization Ranges of Tested Coils

| | Circumferential Carburization | Accuracy of |
|---|---|---|
| Material | Range | detection |
| 25Cr—35Ni | 15-25% | 78-87% |
| 35Cr—45Ni | 30-45% | 79-85% |
| 30Cr—45Ni | 30-40% | 75-83% |
| (Centralloy ® HT E) | | |

As indicated in Table 1, a first coil included an alloy material including 25 weight percent (wt. %) chromium and 35 wt. % nickel, and a second coil included an alloy material including 35 wt. % chromium and 45 wt. % nickel. A third coil included an alloy material including 30 wt. % chromium and 45 wt. % nickel, sourced in this experiment as a coil of Centralloy® HT E material, as produced by Schmidt+Clemens GmbH+Co. KG of Lindlar, Germany. The Centralloy® HT E material is described as a cast nickel-base alloy, having a composition of 0.45 wt. % carbon, 30.00 wt. % chromium, 45.00 wt. % nickel, 0.50 wt. % niobium, 4.00 wt. % aluminum, and 20.05 wt. % iron.

Using the presently disclosed systems and methods for detecting carburization, a circumferential carburization range and an associated accuracy of detection were determined. For example, the first coil of 25Cr-35Ni material was determined to include a circumferential carburization range of 15-25%, with a detection accuracy of 78-87%. The second coil of 35Cr-45Ni material was determined to include a circumferential carburization range of 30-45%, with a detection accuracy of 79-85%. Additionally, the third coil of 30Cr-45Ni material was determined to include a circumferential carburization range of 30-40%, with a detection accuracy of 75-83%.

These experiments indicate that a suitable reliability is provided herein for enabling non-destructive testing of various ethylene furnace coils. Additional experiments can be performed to provide further increased detection accuracy based on establishing a curve or model for each material, with varied levels of carburization and further considering cross-sectional dimensions of each coil. Moreover, as coils in operation undergo carburization and are eventually removed or retired from a furnace, the retired coils can be used effectively in additional experiments according to the presently described methods to further enhance the reliability and accuracy of carburization detection and quantification.

While particular terms and concepts are incorporated in the present disclosure, Applicant notes that the disclosed terms and concepts are exclusively utilized in a descriptive capacity and should not therefore be construed or interpreted as limiting in any way. Certain embodiments and aspects of the disclosed systems, processes and methods have been described in detail with particular reference to the illustrated embodiments. However, it will be apparent that numerous and various modifications and alterations may be made within the spirit and scope of the embodiments of systems, processes and methods described herein, and such modifications and changes are to be considered equivalents and within the breadth and scope of the disclosure.

The use of the words “a” or “an” when used in conjunction with the term “comprising,” “including,” “containing,” or “having” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “about” refers to a range of values including the specified value, which a person of ordinary skill in the art would consider reasonably similar to the specified value. In embodiments, “about” refers to values within a standard deviation using measurements generally acceptable in the art. In one non-limiting embodiment, when the term “about” is used with a particular value, then “about” refers to a range extending to ±10% of the specified value, alternatively ±5% of the specified value, or alternatively ±1% of the specified value, or alternatively ±0.5% of the specified value. In embodiments, “about” refers to the specified value.

When ranges are disclosed herein, ranges from any lower limit may be combined with any upper limit to recite a range not explicitly recited, as well as ranges from any lower limit may be combined with any other lower limit to recite a range not explicitly recited, in the same way, ranges from any upper limit may be combined with any other upper limit to recite a range not explicitly recited. Additionally, reference to values stated in ranges includes each and every value within that range, even though not explicitly recited. Thus, every point or individual value may serve as its own lower or upper limit combined with any other point or individual value or any other lower or upper limit, to recite a range not explicitly recited.

What is claimed is:

1. A method, comprising:
directing photons having an energy in a range from 80 to 140 kiloelectronvolts (keV) toward a coil of an ethylene furnace;
obtaining a photon count for the photons that are emitted from the coil; and
determining an amount of carburization in the coil based on the photon count.

2. The method of claim 1, wherein the directing comprises directing the photons onto a first side of the coil, and wherein the obtaining comprises obtaining a photon count for photons emitted from a second side of the coil, the second side being opposite the first side.

3. The method of claim 1, wherein the obtaining comprises using computed tomography (CT) with a complementary metal-oxide semiconductor (CMOS) panel.

4. The method of claim 1, wherein the determining comprises comparing the photon count to a predetermined model indicating a relationship between photon counts and amounts of carburization.

5. The method of claim 4, wherein the predetermined model comprises one or more of a curve, a chart, a table, or a mathematical expression.

6. The method of claim 4, comprising selecting the predetermined model from a plurality of predetermined models based on a material of the coil.

7. The method of claim 4, comprising generating the predetermined model by:
acquiring a plurality of coils each having a respective amount of carburization; and
directing photons toward the plurality of coils to determine a relationship between the respective amount of carburization and photon count for each coil of the plurality of coils.

8. The method of claim 1, comprising:
determining whether the amount of carburization exceeds a predetermined threshold amount of carburization; and
activating an alarm or transmitting an alert in response to the amount being greater than the threshold amount.

9. The method of claim 1, wherein the range comprises from 80 to 100 keV.

10. A system, comprising:
an irradiation device;
a photon detector;
a controller communicatively coupled to the irradiation device and the photon detector and comprising processor-executable instructions to:
instruct the irradiation device to direct photons having an energy in a range from 80 to 140 kiloelectronvolts (keV) toward a coil of an ethylene furnace;
obtain a photon count for the photons that are emitted from the coil via the photon detector; and
quantify an amount of carburization in the coil based on the photon count.

11. The system of claim 10, wherein the controller is configured to quantify the amount of carburization by comparing the photon count to a predetermined model indicating a relationship between photon counts and amounts of carburization for a material of the coil, and wherein the material of the coil comprises an alloy containing chromium, nickel, and iron.

12. The system of claim 10, wherein the controller is configured to:
determine whether the amount of carburization exceeds a threshold amount; and
activate an alarm or transmit an alert in response to the amount being greater than the threshold amount.

13. The system of claim 10, wherein the irradiation device is configured to direct the photons onto a first side of the coil, and wherein the photon detector is configured to obtain a photon count for photons emitted from a second side of the coil, the second side being opposite the first side.

14. The system of claim 10, comprising a pipe crawler coupled to support the irradiation device and the photon detector, wherein the pipe crawler is configured to translate along an outer surface of the coil and maintain the irradiation device and the photon detector at a constant distance from the outer surface.

15. The system of claim 10, wherein the photon detector comprises a complementary metal-oxide semiconductor (CMOS) panel, and wherein the range comprises from 85 to 135 keV.
